(19) United States
(12) Patent Application Publication
(10) Pub. No.: US 2022/0314807 A1
(43) Pub. Date: Oct. 6, 2022

(54) Circuit Assembly For The Diagnosis Of A Service Disconnect Line Of An Electrically Operated Vehicle

(71) Applicant: Vitesco Technologies GmbH, Regensburg (DE)

(72) Inventor: Harald Schmaus, Donaustauf (DE)

(73) Assignee: Vitesco Technologies GmbH, Regensburg (DE)

(21) Appl. No.: 17/807,755

(22) Filed: Jun. 20, 2022

Related U.S. Application Data
(63) Continuation of application No. PCT/EP2021/050179, filed on Jan. 7, 2021.

(30) Foreign Application Priority Data
Jan. 10, 2020 (DE) 10 2020 200 260.6

(51) Int. Cl. B60L 3/04; B60L 3/00

(52) U.S. Cl. CPC B60L 3/04; B60L 3/0069

(57) ABSTRACT

The disclosure provides a circuit assembly for the diagnosis of a service disconnect line of an electrically operated vehicle with two on-board networks having voltages of different levels. The service disconnect line is connected between a first terminal and a second terminal and includes at least one manual disconnecting element. During the operation of the circuit assembly, a computing device evaluates voltage information representing the voltage present at the second terminal. The computing unit disconnects or does not disconnect the high-voltage on-board network from consumers connected to it. The computing unit detects a fault in the service disconnect line, to iteratively impress different voltage or current levels by operating respective switching elements at the first terminal and/or the second terminal, to acquire the respective voltage present at the second terminal, and for the computing unit to evaluate the voltage information that represents the voltage.

### CROSS-REFERENCE TO RELATED APPLICATIONS

This application claims the benefit of PCT Application PCT/EP2021/050179, filed Jan. 7, 2021, which claims priority to German Application 10 2020 200 260.6, filed Jan. 10, 2020. The disclosures of the above applications are incorporated herein by reference.

### TECHNICAL FIELD

The disclosure relates to a circuit assembly for the diagnosis of a service disconnect line of an electrically operated vehicle with two on-board networks with voltages of different levels.

### BACKGROUND

Electrically operated vehicles have two on-board networks with voltages of different levels. A low-voltage on-board network, typically 12 V, 24 V or 48 V, is used to supply electrical consumers of low power such as for example control devices, lights, comfort and ventilation systems, navigation systems, driver assistance systems and the like. An on-board network with a high voltage, also known as the high-voltage on-board network, is used to supply electrical consumers of high powers such as, for example, an electric drive of the electric vehicle. The voltage in the high-voltage electrical system can here be 400 V or more, depending on its design.

In the present application, an electrically operated vehicle refers to a purely battery-operated vehicle (battery electric vehicle, BEV) that has only an electric motor as the drive source, or to a hybrid electrically operated vehicle (hybrid electric vehicle, HEV, or plug-in hybrid electric vehicle, PHEV) that has a combination of a combustion engine and an electric motor as drive sources. An electric vehicle refers not only to motor vehicles, but to all electrically operated vehicles such as, for example, industrial trucks or forklift trucks.

Due to the presence of two on-board networks with voltages of different levels, safety challenges arise in the event of an accident and during servicing work. Any work on or manipulation of the high-voltage components of the electric vehicle can in some circumstances be life-threatening. Neither workshop personnel during servicing or repair work, nor first-aid workers or fire service personnel in the case of an accident, may come into contact with the high voltage of the high-voltage on-board network. A manual disconnecting element, also known as a manual service disconnector, is therefore provided in what is known as a service disconnect line for the fast, secure voltage disconnection.

The manual disconnecting element is located in the service disconnect line, and, when the manual disconnecting element is opened, a state that is safe for the workshop personnel or for emergency workers is brought about. For this purpose, when the circuit assembly is in operation, the voltage present, for example, at a terminal is acquired with a measuring device, where the voltage changes depending on whether the manual disconnecting element is open or closed. Voltage information representing the voltage is evaluated here by a computing unit, where the computing unit deactivates the high-voltage on-board network if an open state of the manual disconnecting element or of the service disconnect line has been brought about (for example due to deliberate disconnection by an emergency worker).

A disadvantage of the solution that has been in use until now is that detection of a fault state at the terminal at which the voltage is evaluated is incomplete in various fault situations.

### SUMMARY

The disclosure provides a functionally improved circuit assembly for the diagnosis of a service disconnect line of an electrically operated vehicle with two on-board networks having voltages of different levels. One aspect of the disclosure provides a circuit assembly for the diagnosis of a service disconnect line of an electrically operated vehicle with two on-board networks with voltages of different levels. The service disconnect line includes at least one manual disconnecting element and, optionally, a fuse, and is connected between a first terminal and a second terminal. During the operation of the circuit assembly in the vehicle, a voltage present at the second terminal is acquired using a measuring device, and voltage information representing the voltage is evaluated by a computing unit. The computing unit is designed, depending on the voltage information, to disconnect or not disconnect the high-voltage on-board network from consumers connected to it.

Another aspect of the disclosure provides a circuit assembly for the diagnosis of a service disconnect line of an electrically operated vehicle include two on-board networks having voltages of different levels. The service disconnect line is connected between a first terminal and a second terminal. Additionally, the service disconnect line includes at least one manual disconnecting element. A fuse can, moreover, optionally be provided in the service disconnect line. During the operation of the circuit assembly in the vehicle, a voltage present at the second terminal is acquired using a measuring device, and voltage information representing the voltage is evaluated by a computing unit. The computing unit is designed, depending on the voltage information, to disconnect or not disconnect the high-voltage on-board network from consumers connected to it.

In some examples, the computing unit is further designed to carry out a test routine to detect a fault in the service disconnect line, to iteratively impress different voltage or current levels by operating respective switching elements at the first terminal and/or the second terminal, to acquire the respective voltage present at the second terminal with the measuring device, and to evaluate the voltage information that represents the voltage by the computing unit.

The computing unit is designed to detect a short circuit of the service disconnect line to the potential of the low-voltage on-board network or to a reference potential as a fault. The computing unit is furthermore designed to detect, as a fault, an interruption in the service disconnect line that is not caused by actuation of the manual disconnecting element or deliberate disconnection of the service disconnect line made by emergency personnel.

The circuit assembly ensures improved safety for workshop personnel or emergency personnel since, in the absence of monitoring, a short circuit of the second terminal to the potential of the low-voltage on-board network could prevent creation of the safe state in spite of deliberately opening the manual disconnecting element. Furthermore, without the proposed monitoring by the circuit assembly, a short circuit of the second terminal to the reference potential could prevent the creation of a drivable state of the vehicle.

The disclosure is therefore based on the consideration that the recognition of a fault state at the second terminal, which is the terminal 30c (abbreviated: K130c) of the vehicle is not possible solely by evaluating the voltage level of the voltage present in the low-voltage on-board network. The detection of a short circuit or of an interruption of the second terminal rather requires an actively impressed change in the voltage and/or current level at the second terminal.

The described circuit assembly provides a remedy in that the computing unit is designed to perform a test routine, to iteratively drive respective switching elements at the first and/or second terminal, whereby different voltage or current levels are impressed. The voltage present at the second terminal resulting from this can then be acquired with the measuring device. The voltage information representing the voltage is here evaluated by the computing unit which consequently can conclude the presence of a fault or deliberate disconnection of the service disconnect line, for example by opening the manual disconnecting elements or a mechanical disconnection by emergency personnel.

In some implementations, a switchable voltage supply is provided, a first controllable switching element is connected between a supply voltage and a node point of a voltage divider consisting of two resistors. The supply voltage can, for example, be derived from the low-voltage on-board network, and can, for example, be 12 V, 24 V or 48 V. The series connection of the voltage divider consisting of the two resistors is connected between the first terminal and a reference potential.

In some examples, the computing unit is designed to drive the first switching element successively from a conductive state into a non-conductive state, and to conclude the presence of a short circuit of the service disconnect line to the potential of the low-voltage on-board network if the potential of the low-voltage on-board network is detected at the second terminal in both switch positions of the first switching element.

In some implementations, a second controllable switching element is connected to the second terminal via a resistor. The computing unit is expediently designed to drive the second switching element successively from a conductive state into a non-conductive state, or vice versa, and to conclude the presence of a short circuit of the service disconnect line to the reference potential if the reference potential is detected at the second terminal in both switch positions of the second switching element.

In some examples, in which current sources and current sinks are used, a current is impressed into the first terminal through a first, fixed or changeable current source. The computing unit is designed to conclude the presence of a short circuit of the circuit disconnect line to the potential of the low-voltage on-board network if the potential of the low-voltage on-board network is detected at the second terminal.

In some implementations, the computing unit is designed to conclude the presence of a short circuit of the service disconnect line to the reference potential of the on-board network if the reference potential of the on-board network is detected at the second terminal.

In some examples, the second terminal is connected to a switchable current source assembly via a resistor, so loading the second terminal or injecting a current into it.

As already described above, the second terminal is the terminal 30c (abbreviated: K130c) of the vehicle. In contrast, the first terminal is a terminal specific for the test cycle, and in particular differs from the terminal 30 (K130) of the vehicle.

In some examples, the computing unit is designed to carry out the test routine once for each journey or for each charge cycle of the vehicle. Alternatively or in addition, the computing unit can be designed to perform the test routine cyclically when the vehicle is operating.

An incorrect evaluation of the voltage signal present at the second terminal can be prevented by the proposed circuit assembly, whereby, hazardous and undesirable vehicle states can be avoided or prevented.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 shows a known prior art circuit assembly in which the conventional wiring of a service disconnect signal loop is illustrated.

FIG. 2 shows a first exemplary a circuit assembly with a switchable voltage supply.

FIG. 3 shows a second exemplary circuit assembly with current sources and current sinks.

Like reference symbols in the various drawings indicate like elements.

### DETAILED DESCRIPTION

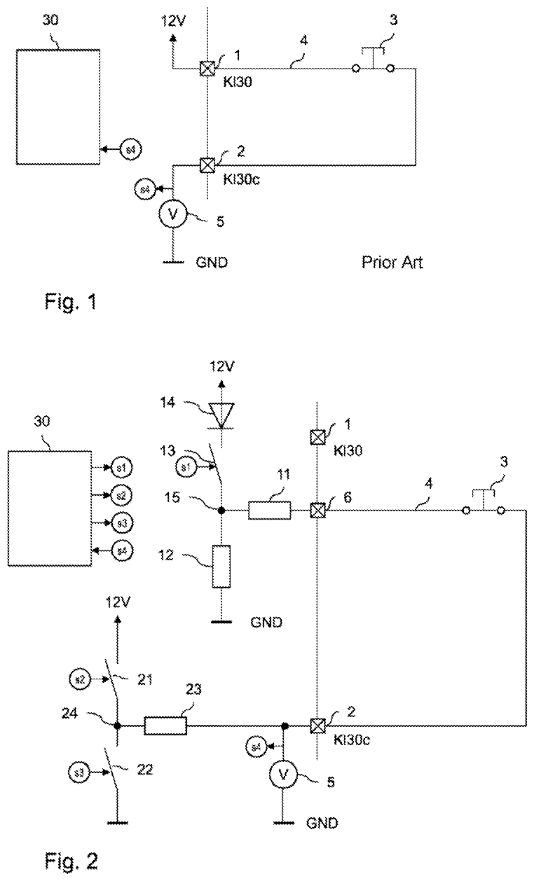

FIG. 1 shows a known circuit assembly of a service disconnect signal loop commonly used in electrically driven vehicles that serves to bring about a safe state for workshop personnel or emergency personnel.

The signal loop is formed by a service disconnect line 4 (referred to below as the line 4), in which a manual disconnecting element 3 in the form, for example, a disconnector, is arranged. The line 4 is connected between a terminal 1, which is the terminal 30 (K130) of the vehicle, and a terminal 2, which is the terminal 30c (K130c) of the vehicle.

The terminal 1 is connected to the low-voltage on-board network, e.g., 12 V. If the low-voltage on-board network has a voltage different from 12 V, for example 24 V, then the terminal 1 is connected to 24 V. A measuring device 5 is connected to the terminal 2. The voltage currently present at the terminal 2 (K130c) is acquired by the measuring device 5. Voltage information s4 representing the voltage is sent to a computing unit 30, e.g., a control unit, and evaluated by it.

If the voltage information s4 corresponds to the voltage of the on-board network, not illustrated in detail, with the low voltage (in this case 12 V), then the line 4 connects the terminals 1 and 2 to one another. A high voltage battery, not illustrated in the figures, which is part of an on-board network, also not illustrated, with a high voltage (referred to below as the high-voltage on-board network), may then be connected to a wiring harness and/or to consumers of the high-voltage on-board network.

If the line 4 is separated by the manual disconnecting element 3 then the voltage information s4 ascertained by the measuring device 5 corresponds to the reference potential GND (it being assumed here that the high-voltage on-board network and the low-voltage on-board network have the same reference potential GND). The computing unit 30 then drives a corresponding switching element to disconnect the high-voltage battery from the cable harness and/or the consumers of the high-voltage on-board network.

The disconnection of the line 4 can also be brought about through mechanical (for example forcible) disconnection of the line 4, for example by cutting with shears performed by emergency personnel, instead of the manual disconnecting element 3 that is operated by workshop personnel.

A short circuit between the terminal 2 (K130c) to a line of the on-board network with low voltage (i.e., 12 V) could prevent the creation of a safe state following the deliberate opening of the manual disconnecting element 3 or a manual disconnection of the line 4.

A short circuit between the terminal 2 (K130c) to the reference potential GND could also prevent the creation of a drivable state.

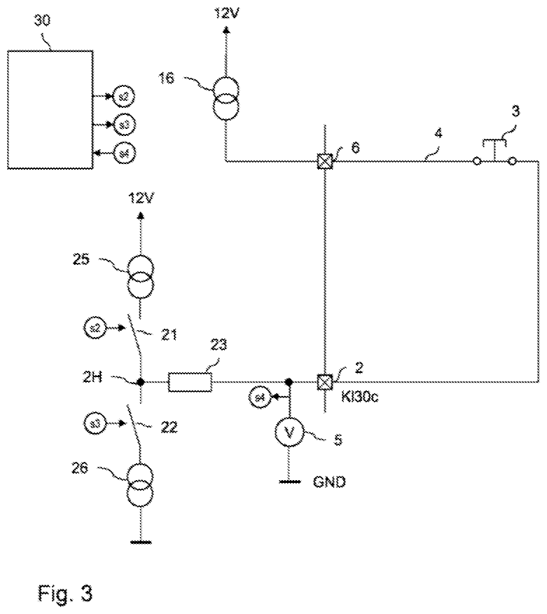

As shown in FIGS. 2 and 3 the detection of a fault state at the terminal 2 (K130c) is allowed, in that it causes an actively impressed change to the voltage and/or current level at the terminal 2 (K130c). The terminal 2 (K130c) corresponds to a second terminal in the present description.

FIG. 2 shows a circuit assembly in which a change in the voltage level at the second terminal 2 (K130c) occurs. In contrast to the arrangement according to FIG. 1 known from the prior art, the line 4 is now connected between the second terminal 2 (K130c) and a first terminal 6 which is a terminal specifically only for the test cycle and is different from the terminal 1 (K130) of the vehicle. The manual disconnecting element 3 is in turn connected in the line 4. The terminal 1 (K130) does not play a part in the present circuit assembly, and is only shown in FIG. 2 for information purposes, to illustrate that the first terminal 6 is a different terminal from the terminal 1 (K130).

A first controllable switching element is connected between a node point 15 of a voltage divider having two resistors and a diode 14 that is connected to a supply voltage, e.g., 12 V. The supply voltage can, for example, be the on-board network voltage of the low-voltage on-board network. Fundamentally, the supply voltage can also be a voltage different from that. The controllable switching element 13 is switched to be conductive or blocking by a drive signal s1 from the computing unit 30 already described. The series connection of the voltage divider 11, 12 consisting of two resistors is connected between the first terminal 6 and the reference potential GND.

An optional, second controllable switching element 21 is connected via a resistor 23 to the second terminal 2 (K130c). The other end of the second controllable switching element 21 is connected to the supply voltage (in this case, 12 V). A further, optional, third controllable switching element 22 that is connected between a node point 24, formed between the second controllable switching element 21 and the resistor 23 and the reference potential GND is also drawn. The second controllable switching element 21 is switched by the computing unit 30 to be conductive of locking using a second drive signal s2. The third controllable switching element 22 is switched to be conductive or blocking by a third drive signal s3 from the computing unit 30.

For simplified functionality of the circuit assembly, the switch arrangement connected to the second terminal 2 (K130c) can be entirely or partially omitted.

The computing unit 30 is designed to drive the first switching element 13 successively from a conductive state into a non-conductive state. If the potential of the low-voltage on-board network is detected at the second terminal 2 (K130c) in the two sequentially present switch positions of the first switching element 13, the computing unit 30 will conclude the presence of a short circuit on the line 4. The presence of the second and third controllable switching elements 21, 22 is not necessary to carry out this test. For the case in which these two controllable switching elements are, however, present, they are each switched into a blocking state.

The different variants of switch positions of the first switching element and voltage information s4 obtained at the second terminal (K130c) are presented again in the following table:

TABLE 1
Fault state matrix

| switching element 13 | | |
|---|---|---|
| terminal 2 (K130c) | conductive | blocking |
| approx. 12 V | connection OK | short circuit to 12 V |
| | or short circuit | |
| | to 12 V | |
| 0 V | line break or | connection OK or |
| | disconnecting | line break or |
| | element closed | disconnecting |
| | | element open |
| | | or short circuit |
| | | to reference |
| | | potential GND |

To conclude the presence of a short circuit between the line 4 and the reference potential GND, the computing unit 30 is designed to drive the second switching element 21 successively from a conductive state into a non-conductive state. The switching sequence can also be inverted. While the second controllable switching elements 21 is driven, the first and the third controllable switching elements 13, 22 are each switched into the blocking state. If the reference potential is detected at the second terminal 2 (K130c) in both switch positions of the second switching element 21, it is possible to conclude the presence of a short circuit between the line 4 and the reference potential.

FIG. 3 shows a circuit assembly in which current sources and current sinks are used instead of a switchable voltage supply. The first terminal 6 is connected to a first current source 16 that is supplied by the supply potential 12 V (either the supply voltage of the on-board network, or a supply voltage different from that). A switch arrangement including the first and the second controllable switching elements 21, 22 is connected to the second terminal 2 (K130c). The first controllable switching element 21 is connected here between the node point 24 and a reference potential voltage source 25. The current source 25 is connected to the supply potential 12 V. The second controllable switching element 22 is connected between the node point a 24 and a current source 26 that is connected to the reference potential.

The computing unit 30 is designed to conclude the presence of a short circuit of the line 4 to the potential of the low-voltage on-board network if the potential of the low-voltage on-board network is detected at the second terminal (K130c). The second and third controllable switching elements 21, 22 are switched into the blocking state for this check.

The presence of a short circuit between the line 4 to the reference potential GND of the low-voltage on-board network can be concluded if the reference potential GND of the on-board network is activated at the second terminal 2. The check is made by switching the second controllable switching element 21 into the conductive state and the third controllable switching element 22 into the blocking state.

If the second and the third controllable switching elements s2 and s3 are switched into the conductive state, the switchable current source assembly acts as a voltage divider, whereby a medium voltage, i.e., a voltage between the reference potential and the supply voltage potential (here 12 V) must develop at the second terminal 6 (K130c). If a different potential is present at the terminal 6 (K130c) then a short circuit to the on-board network with low voltage can be concluded.

A number of implementations have been described. Nevertheless, it will be understood that various modifications may be made without departing from the spirit and scope of the disclosure. Accordingly, other implementations are within the scope of the following claims.

What is claimed is:

1. A circuit assembly for diagnosis of a service disconnect line of an electrically operated vehicle with a high-voltage on-board network and a low-voltage on-board network, the circuit assembly comprising:
a first terminal;
a second terminal;
a service disconnect line connected between the first terminal and the second terminal and comprises at least one manual disconnecting element, wherein during the operation of the circuit assembly in the vehicle, a voltage present at the second terminal is acquired using a measuring device; and
a computing unit evaluating voltage information representing the voltage, the computing unit, depending on the voltage information, disconnects or does not disconnect the high-voltage on-board network from consumers connected to it, the computing unit executes a test routine to detect a fault in the service disconnect line, to iteratively impress different voltage or current levels by operating respective switching elements at the first terminal and/or the second terminal, to acquire the respective voltage present at the second terminal with the measuring device, and for the computing unit to evaluate the voltage information that represents the voltage.

2. The circuit assembly of claim 1, wherein the computing unit detects a short circuit of the service disconnect line to a potential of the low-voltage on-board network or to a reference potential as a fault.

3. The circuit assembly of claim 1, wherein the computing unit is designed to detect an interruption in the service disconnect line as a fault.

4. The circuit assembly of claim 1, wherein a first, controllable switching element is connected between a supply voltage and a node point of a voltage divider consisting of two resistors, wherein a series circuit of the voltage divider consisting of the two resistors is connected between the first terminal and a reference potential.

5. The circuit assembly of claim 4, wherein the computing unit drives the first switching element successively from a conductive state into a non-conductive state, and concludes a presence of a short circuit of the service disconnect line to the potential of the low-voltage on-board network if the potential of the low-voltage on-board network is detected at the second terminal in both switch positions of the first switching element.

6. The circuit assembly of claim 4, wherein a second, controllable switching element is connected via a resistor to the second terminal.

7. The circuit assembly of claim 6, wherein the computing unit drives the second switching element successively from a conductive state into a non-conductive state, or vice versa, and to conclude a presence of a short circuit of the service disconnect line to the reference potential if the reference potential is detected at the second terminal in both switch positions of the second switching element.

8. The circuit assembly of claim 1, wherein a current is injected into the first terminal by a first, fixed or changeable current source.

9. The circuit assembly of claim 8, wherein the computing unit determines a presence of a short circuit of the service disconnect line to a potential of the low-voltage on-board network if the potential of the low-voltage on-board network is detected at the second terminal.

10. The circuit assembly of claim 8, wherein the computing unit determines a presence of a short circuit of the service disconnect line to a reference potential if the reference potential of the on-board network is detected at the second terminal.

11. The circuit assembly of claim 8, wherein the second terminal is connected to a switchable current source assembly via a resistor, so loading the second terminal or injecting a current into it.

12. The circuit assembly as of claim 1, wherein the second terminal is the terminal of the vehicle.
